(19) United States
(12) Patent Application Publication
(10) Pub. No.: US 2006/0006729 A1
(43) Pub. Date: Jan. 12, 2006

(54) Composite wheel beam key

(75) Inventor: Anthony J. Rutten, South Bend, IN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/073,309

(22) Filed: Mar. 7, 2005

Related U.S. Application Data
(60) Provisional application No. 60/585,585, filed on Jul. 7, 2004.

(51) Int. Cl. B60B 19/00

(52) U.S. Cl. 301/6.2

(57) ABSTRACT

A carbon-carbon composite or carbon-ceramic composite wheel beam key (22, 44). The carbon-carbon composite wheel beam keys (22, 44) have a density of at least 1.5 g/cc. The carbon-carbon composite wheel beam keys (22, 44) of this invention will also have an internal porosity of 10% or less. An aircraft wheel (23, 46) and beam key (22, 44) assembly including a wheel (23, 46) having an outrigger boss about its rim edge and brackets (33, 66) mounted in its spoke face, and beam keys (22, 44) as described above. To attach the beam keys (22, 44) to the wheel (23, 46), the necks (32, 64) of the beam keys are held by the brackets (33, 66) and bolts (20) or rivets pass through the bores 26, 52) of the beam keys (22, 44). The composite wheel beam keys are manufactured by forming a fibrous preform blank in a shape of a desired wheel beam key and densifying the fibrous preform to produce a carbon-carbon composite in the shape of said wheel beam key. When the fibrous preform is manufactured entirely from carbon fiber precursors, it is preferable that a majority of the fibers in the preform be oriented in the length direction of the key and a minor portion of the fibers in the preform extend in the other two perpendicular directions of the key. The resulting C—C composite wheel beam key may be immersed in antioxidant to provide an antioxidant-coated carbon-carbon composite wheel beam key. Also, a hard, wear-resistant coating may be applied to the antioxidant-coated beam key.

This application claims priority under 35 U.S.C. §119(e) to provisional application Ser. No. 60/585,585, filed Jul. 7, 2004. The entire disclosure of Ser. No. 60/585,585 is incorporated by reference herein.

### FIELD OF THE INVENTION

The present invention relates to wheel beam keys such as are utilized in aircraft wheel and beam key assemblies. In accordance with this invention, the wheel beam keys are composed of carbon-carbon composite or carbon-ceramic composite materials.

### BACKGROUND OF THE INVENTION

Aircraft brakes typically are made with a stack of alternatively interleaved stator and rotor discs, the discs being adapted for selective frictional engagement with one another. The stator discs are typically splined to the axle of the aircraft, while the rotors are keyed to the wheel, generally by a series of beam keys that are circumferentially spaced about an inner portion of the wheel and that engage key slots in the outer circumferential surface of the rotors. The beam keys typically have one end thereof pinned to the wheel and an opposite end thereof mounted to an outrigger flange of the wheel.

Over the years, much effort has gone into the improvement of various aspects of aircraft landing system components and related technologies. A few of the patents that have issued are: U.S. Pat. No. 2,875,855, “Wheel and Brake Assembly for Aircraft Landing Gear”, Bendix Aviation Corporation, of South Bend, Ind.; U.S. Pat. No. 3,345,109, “Airplane Disc Brake and Key Combination”, The Goodyear Tire & Rubber Company, of Akron, Ohio; U.S. Pat. No. 3,836,201, “Wheel Assemblies”, Dunlop Limited of London, England; U.S. Pat. No. 5,024,297, “Torque Transmitting Beam for Wheel Having Brake Torque Drives”, The B.F. Goodrich Company, of Akron, Ohio; U.S. Pat. No. 5,186,521, “Wheel and Drive Key Assembly”, Allied-Signal Inc., of Morristown, N.J.; and U.S. Pat. No. 6,003,954, “Aircraft Wheel and Beam Key Attachment”, Aircraft Braking Systems Corporation, of Akron, Ohio.

Current alloy wheel keys are relatively very heavy and tend to be expensive to produce. They also have limitations on high temperature exposure. Many current beam key feet are made of metal alloys, which—in addition to weight considerations—have issues on thermal conductivity at high temperatures. The present invention provides alternatives to prior art wheel beam keys and fittings. The components provided by the present invention are advantageous both economically and with respect to their enhanced performance characteristics.

### SUMMARY OF THE INVENTION

The present invention provides wheel beam keys that are made from a mostly unidirectional carbon-carbon composite material. In addition to carbon-carbon composite materials, however, the present invention also contemplates composite beam keys made with hybrid fibers (carbon or ceramic) and/or hybrid matrices (carbon or ceramic). For example, a wheel beam key of the present invention may be made using two cycles of carbon densification followed by one cycle of treatment with SiC carbide or another ceramic. While the carbon-carbon composite beam keys of this invention will generally have anti-oxidant and/or wear coatings applied to them, when ceramic matrices are used, the ceramic will often provide sufficient oxidative and wear resistance.

The wheel beam keys of this invention are significantly higher in both strength-to-weight and stiffness-to-weight ratios than are comparable alloy keys. The wheel beam keys of this invention provide large weight reduction as compared to alloy keys. For instance, a conventional alloy beam key for a 23-inch wheel weighs 2.8 pounds. A comparable C—C key weight is approximately 1 pound, for a 65% weight reduction. Also, the wheel beam keys of this invention can withstand higher service temperatures than do comparable steel keys. The carbon-carbon composite keys of this invention have a wider web than do conventional wheel beam keys. This provides stiffer keys with less wasted space inside of the wheel.

Although rotor inserts can be used with the wheel beam keys of this invention, the composite beam keys of this invention can engage rotors without the necessity for rotor slot inserts. A conventional steel beam key, in contrast, requires a steel insert to engage.

One embodiment of the present invention is a carbon-carbon composite or carbon-ceramic composite wheel beam key. Such wheel beam keys are typically configured as generally rectangular bodies, each having shoulders and a neck located at one end thereof and a through bore located at the opposite end thereof. In accordance with this invention, it is preferred that that carbon-carbon composite wheel beam key has a majority of its fibers aligned in the length direction of the key. The carbon-carbon composite wheel beam key of this invention will have a density of at least 1.5 g/cc, and possibly up to 2.1 g/cc, with preferred densities varying based on types of materials used. The carbon-carbon composite wheel beam key of this invention will also have a maximum internal porosity of 10% or less. The maximum internal porosity of the carbon-carbon composite wheel beam key of this invention may be only 5% or even 1% or less.

Another embodiment of the present invention is an aircraft wheel and beam key assembly. An aircraft wheel and beam key assembly in accordance with this invention will include a wheel having an outrigger boss at the rim edge and brackets mounted at the spoke face. It will also include beam keys as described above. To attach the beam keys to the wheel, the necks of the beam keys are held by the brackets and bolts or rivets pass through the bores of the beam keys.

Still another embodiment of the present invention is a method of manufacturing a composite wheel beam key. This method includes the steps of: forming—entirely from carbon fibers or from carbon fibers and ceramic materials—a fibrous preform blank in a shape of a desired wheel beam key; and densifying the fibrous preform to produce a carbon-carbon composite in the shape of said wheel beam key. When the fibrous preform is manufactured entirely from carbon fiber precursors, it is preferable that a majority of the fibers in the preform be oriented in the length direction of the key and a minor portion of the fibers in the preform extend in the other two perpendicular directions of the key. The resulting C—C composite wheel beam key may be immersed in antioxidant to provide an antioxidant-coated carbon-carbon composite wheel beam key. Also, a hard, wear-resistant coating may be applied to the antioxidant-coated beam key.

The present invention provides a method of reducing the weight of an aircraft landing system brake assembly. This method contemplates employing a composite wheel beam key as described hereinabove as a component in the aircraft landing system brake assembly.

This invention also provides a method of enhancing the high temperature performance of an aircraft landing system brake assembly. This method of the invention includes the steps of: forming a fibrous preform in the shape of the desired wheel beam key, with a majority of the fibers in the preform being aligned in the length direction of the key and with a minor portion of the fibers in the preform extending in the other two axial directions of the key; densifying the fibrous preform to produce a carbon-carbon composite in the shape of the wheel beam key; coating the C—C composite wheel beam key with antioxidant; and employing the resulting coated carbon-carbon composite wheel beam key as a component in the aircraft landing system brake assembly.

### BRIEF DESCRIPTION OF THE DRAWINGS

The present invention may be more fully understood from the detailed description given below and the drawings that accompany this specification. The drawings are given by way of illustration only, and thus are not limiting of the present invention. The drawings are not necessarily to scale.

FIG. 1 is an assembly illustration of a beam key and wheel assembly according to the invention, showing a partial section of the wheel assembly.

FIG. 2A is an isometric view of a beam key in accordance with this invention.

FIG. 2B is an isometric view of a beam key bolt that can be used in accordance with this invention.

FIG. 2C is an isometric view of a beam key foot that can be used in accordance with this invention. Various slotting or channeling configurations can be used to reduce bearing contact and thermal conduction.

FIG. 2D is an isometric view of a beam key bracket that can be used in accordance with the present invention.

FIG. 3A is a perspective view of a beam key according to the invention.

FIG. 3B is a top plan view of the beam key of FIG. 3A.

FIG. 4A is a perspective view of an alternate beam key embodiment of the invention.

FIG. 4B is a partial cutaway side view of an alternate beam key and wheel assembly of the invention.

### DETAILED DESCRIPTION OF THE INVENTION

In a typical embodiment of the present invention, the beam key is made from PAN-based carbon fibers with a carbon matrix, with the carbon matrix being densified either entirely by CVI/CVD processing or by a combination of CVI/CVD processing and pitch infiltration, followed by carbonization. Alternatively or in addition to PAN-based carbon fibers, pitch-based carbon fibers and rayon-based carbon fibers may also be used in this invention. Also, the present invention also contemplates utilizing mixed-source carbon fibers (e.g., PAN and pitch fibers) or ceramic fibers (e.g., PAN and/or pitch and/or rayon and/or oxidized PAN and/or SiC and Al₂O₃ fibers), possibly combined with hybrid matrices (e.g., charred resins/CVI/charred pitch or charred phenolic with SiC, B₄C, SiN, etc.). Thus the present invention includes structural carbon-carbon composites, such as carbon fiber CVD-densified composites and carbon fiber CVD/pitch-densified composites and carbon fiber/phenolic-densified composites. The present invention also contemplates structural carbon/ceramic composites, such as carbon/ceramic fiber combinations densified with carbon/ceramic matrices, etc. Such materials provide improved wear resistance and “built in” antioxidant properties. Examples of this approach include carbon fiber/ceramic fiber composites densified with CVD and/or pitch and/or resin, and carbon fiber and/or ceramic fiber composites densified with CVD and/or pitch and/or resin, with silicon infusion to provide SiC ceramic matrix material.

Copending U.S. patent application {H0008112}, entitled “MOLD FIXTURE TO DENSIFY COMPOSITE BEAM KEY USING RESIN TRANSFER MOLDING”, filed on even date herewith, describes one way in which composite wheel beam keys in accordance with the present invention can be manufactured. The entire disclosure of that application is incorporated herein by reference.

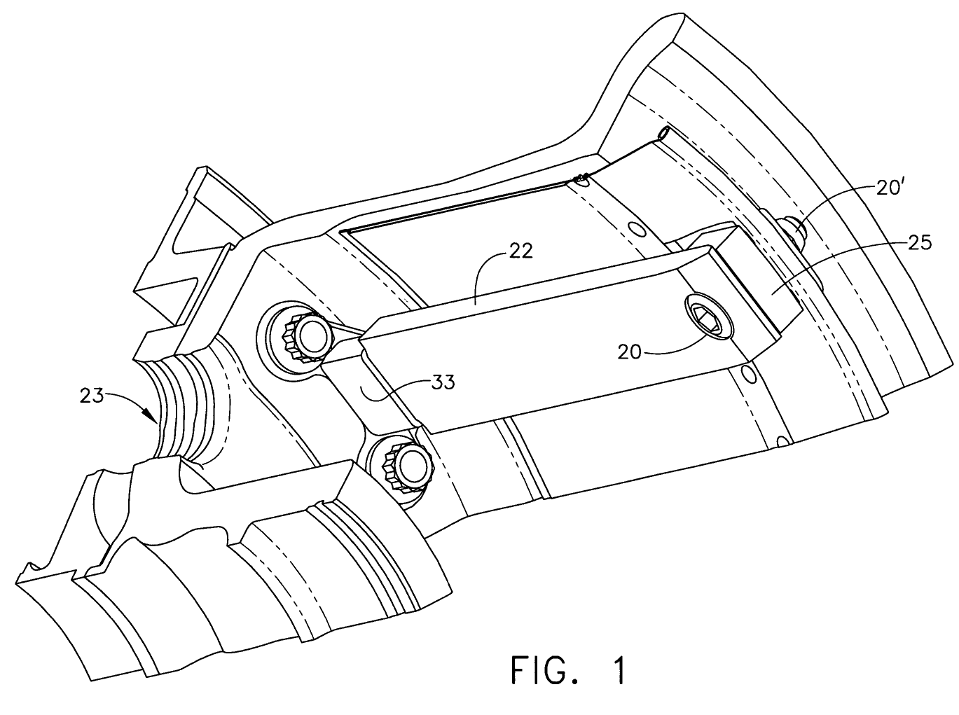

FIG. 1 is an assembly illustration of a beam key and wheel assembly according to the invention, showing a partial section of the wheel assembly. In FIG. 1, a beam key 22 is adapted for interconnection with an aircraft wheel 23 by attachment to the wheel's outrigger boss. A foot 25 is interposed between the beam key 22 and the outrigger boss. A through counterbore (not shown) is provided in a top surface of the beam key 22 and is adapted for receiving a bolt 20 which is secured beneath the outrigger boss by a nut 20′. Foot 25 would typically be made of metal, such as steel or titanium. However, similar “feet” made of carbon-carbon composite or of ceramic composite could likewise be used with the wheel beam key of this invention.

As discussed above, one end of a beam key 22 is secured to an outer circumferential outrigger boss of the wheel 23 by means of a bolt and nut assembly. The opposite end of the beam key 22 is also secured to the wheel 23, by means of engagement of a neck (not shown) in a metal bracket 33. The neck is provided at the end of the beam key 22 away from the bore 26. The neck is adapted for receipt in the bracket 33 provided bolted to the wheel 23.

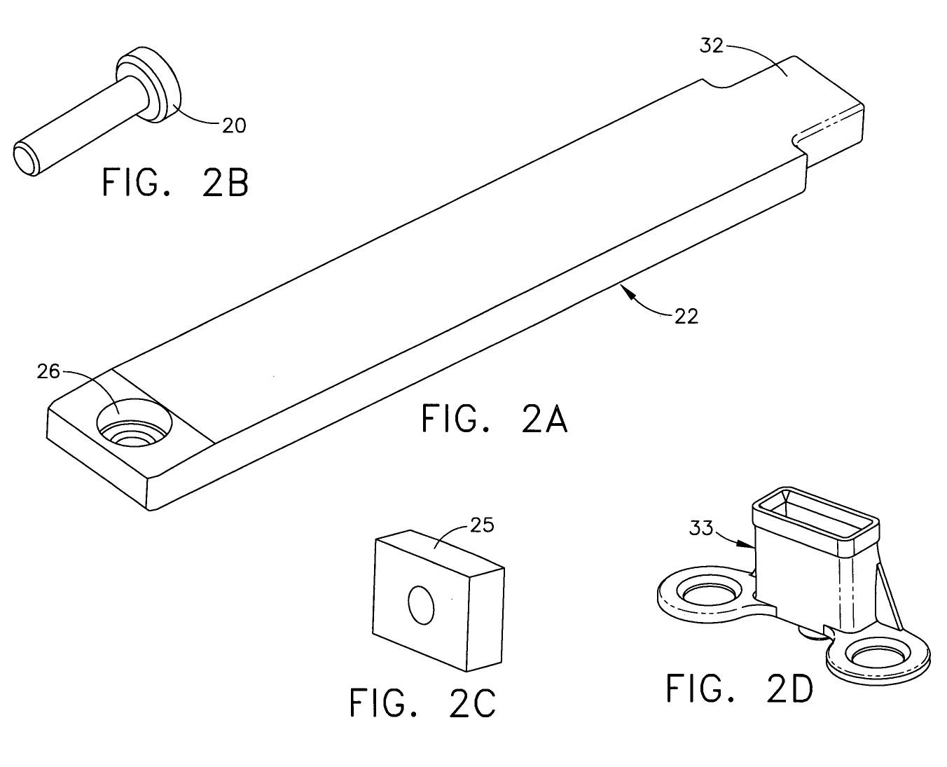

FIGS. 2A-2D are isometric views of a wheel beam key and wheel beam key fittings of the type illustrated in FIG. 1. FIG. 2A shows beam key 22, having at one end a counterbore 26 and at the opposite end a neck area 32. A typical beam key could be, for instance, 13.06 inches in length, 2.06 inches wide, and 0.62 inches thick. FIG. 2B shows beam key bolt 20. A typical beam key bolt could be, for instance, 2.12 inches long. FIG. 2C shows a beam key foot 25. A typical beam key foot could be, for instance, 1.88 inches long, 1.3 inches wide and 0.67 inches thick. FIG. 2D shows a beam key bracket 33. The socket in a typical beam key bracket could be, for instance, 1.447 inches in width, 0.622 inches in thickness, and 1.375 inches in depth. Of course, those skilled in the art will appreciate that all such dimensions are exemplary only, and that extensive variations can be made in the shape and dimensions of the composite wheel beam keys and their accessories in accordance with the present invention.

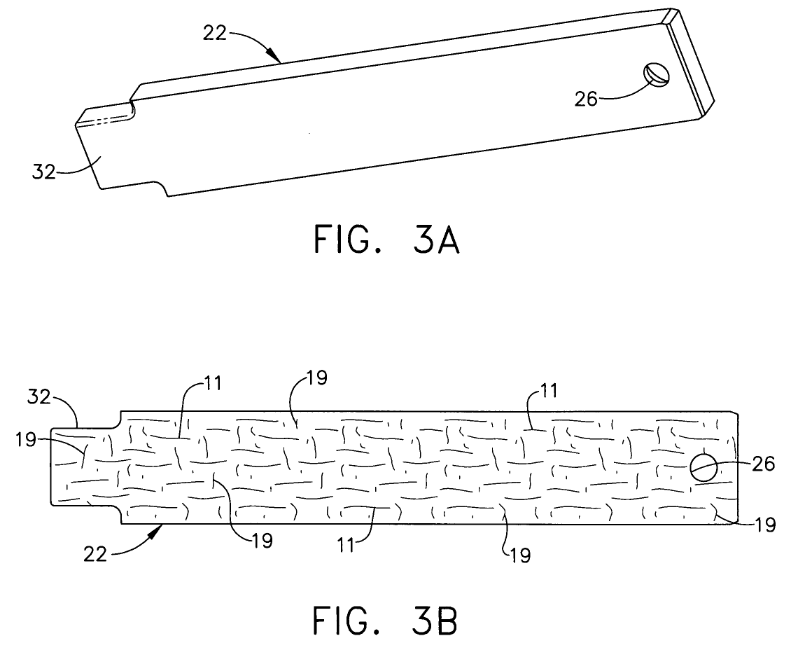

FIG. 3A is a perspective view of a beam key according to the invention. FIG. 3B is a top plan view of the beam key of FIG. 3A. FIGS. 3A and 3B show beam key 22 which is adapted for interconnection with an aircraft wheel. Beam key 22 includes a through counterbore 26 adapted for receiving a bolt secured to an outrigger boss in the wheel and a neck area 32 provided at an end of the beam key and adapted for receipt in a bracket provided on the wheel.

Woven, braided, stitched, needled, oriented short fiber, pultruded, and standard 2-D nonwoven fabric fiber preforms can be employed in this invention. With all of these, a majority of the fibers will be oriented at 0° with respect to the shank of the key at the edges. Along the centerline of the key, the fibers can be oriented at an angle other than 0°, such as +/−45° bias angles, for improvements in shear strength values. All of these processes, except for the 2-D nonwoven fabric process, will place a small quantity of fiber through the thickness of the part to contribute to the structural integrity of the beam key preform. In FIG. 3B, fibers 11 represent fibers oriented generally parallel to the shank of the beam key, and fibers 19 represent fibers oriented through the thickness and width of the beam key (very roughly, perpendicular to the parallel fibers 11), thereby contributing to the structural integrity of the preform.

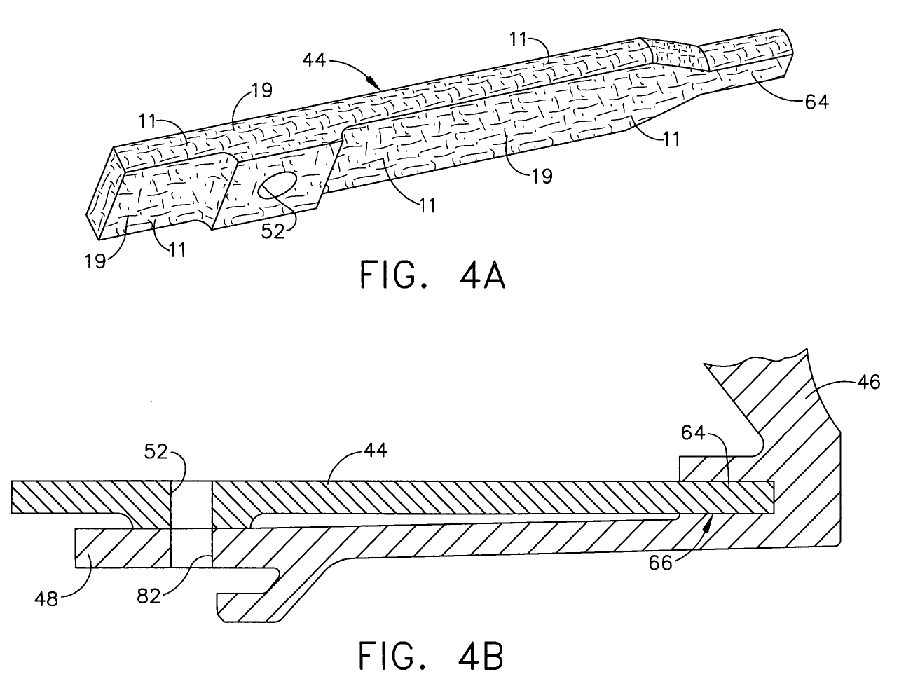

FIG. 4A is a perspective view of an alternate beam key embodiment of the invention. FIG. 4A shows beam key 44, which is adapted for interconnection with an aircraft wheel. Beam key 44 includes a through counterbore 52 adapted for receiving a bolt secured to an outrigger boss in the wheel and a pin 64 provided at an end of the beam key and adapted for receipt in a bore provided within the wheel. In FIG. 4A, fibers 11 represent fibers oriented generally parallel to the shank of the beam key, and fibers 19 represent fibers oriented through the thickness and width of the beam key (very roughly, perpendicular to the parallel fibers 11), thereby contributing to the structural integrity of the preform.

FIG. 4B is a partial cutaway side view of an alternate beam key and wheel assembly of the invention, showing a partial section of the wheel assembly. In FIG. 4B, a beam key 44 is adapted for interconnection with an aircraft wheel 46 by attachment to the wheel's outrigger flange 48. A through bore 52 is provided in the beam key 44 and is adapted for receiving a bolt (not shown) which is secured to the outrigger flange 48 by a nut (not shown). A bore 82 in the outrigger flange is axially aligned with the bore 52 to receive the bolt. The opposite end of the beam key 44 is also secured to the wheel 46, by means of engagement of a pin or post in a bore. As shown in FIG. 4B, a pin 64 is provided at the end of the beam key 44 away from the bore 52. Pin 64 is adapted for receipt in a bore 66 provided within the wheel 46.

Materials and Manufacturing Considerations

Carbon-carbon composite preforms of this invention are manufactured with a majority of their fibers in the length direction of the key. A minor portion of the fibers extend in the other two axial directions to hold the material together and provide for strength in those respective directions. The key is then immersed in antioxidant to prevent high temperature degradation. Similarly, the foot may be made from carbon-carbon composites, generally a balanced 3-D fiber preform. The in-board wheel half may optionally be modified to facilitate stress conditions.

Depending on wear rates due to interaction between the carbon key and carbon rotors, rotor inserts may be omitted. Also depending on wear rates, a wear-resistant coating, for instance of SiC, WC, TaC, or Al₂O₃, may be employed. Friction reducing A/O coatings can also be used to help alleviate wear.

PAN-based (polyacrylonitrile) fibers are currently preferred for making C—C composite preforms in accordance with this invention, but pitch-based and rayon-based carbon fibers can also be used. CVI (carbon vapor infiltration) or liquid pitch infiltration (e.g., employing hot isostatic pressing or resin transfer molding) can be used to deposit densifying carbon precursors into the fibrous matrix. Among the densification techniques currently contemplated in this invention are rough laminar and isotropic CVI and pitch and phenolic RTM (resin transfer molding).

For both C—C composite and ceramic hybrid composite preforms of this invention, the fibers may be provided as nonwoven needled fibers, 3-D woven fibers, short chopped fibers, braided and filament-wound fibers, 2-D laminates, nonwoven non-needled fibers, etc. One approach, for instance, is to use a controlled spray of cut fibers to control fiber orientation and to provide a functionally graded structural composite. The fibers themselves may be, for instance, carbon-producing fibers such as PAN fibers, pitch fibers, oxidized PAN fibers, oxidized pitch fibers, rayon fibers, etc. In accordance with some embodiments of this invention, SiC, SiN, or other ceramic material may also be used as the “fibrous” reinforcement. This may be done either by adding separately manufactured SiC or SiN fibers to the preform or by infusing the preform with molten silicon.

Densification of the preform matrices may be by, for example, gas phase methods such as rough laminar CVI/CVD or isotropic CVI/CVD, or by liquid phase methods using a resin such as Resol or Novalac as a pore filler, using a pitch (petroleum-based, coal tar-based, or synthetic), or by mixtures of these densification techniques.

In accordance with this invention, fiber reinforced composite materials may be formed by impregnating or depositing a matrix within fibrous structures produced as described in this application. Thick fibrous structures used in fiber-reinforced composites are known as “preforms”. Various well known processes may be employed, alone or in combination, to deposit a matrix within the fibrous structure. Such processes include, for instance, chemical vapor infiltration and deposition and resin or pitch impregnation with subsequent pyrolyzation. Suitable processes and apparatuses for depositing a binding matrix within a porous structure are described, for instance, in U.S. Pat. No. 5,480,678, entitled “Apparatus for Use with CVI/CVD Processes”. The disclosure of U.S. Pat. No. 5,480,678 patent is incorporated by reference herein.

More specifically, for instance, after the fibrous skeleton is prepared, that carbon-fiber precursor matrix is infiltrated with molten pitch or with other carbon matrix precursors such as phenolic resin. The impregnated matrix is carbonized, for instance at 700-1500° C. for about 3 hours. This results in a carbon-carbon composite preform having a density of, for instance, approximately 1.25 grams per cubic centimeter. This preform may then be heat-treated to further open the porosity prior to additional densification. Alternatively, further densification may be carried out without heat treatment.

Whether the preform is heat-treated or not, for most applications the resulting preform is further densified. The densification processes that are used may be liquid phase resin densification followed by carbonization and/or densification may be accomplished by conventional CVI/CVD processes, as described above. Typically, combinations of these processes will be used until the carbon-carbon composite reaches a density in the range of 1.60 to 1.95 grams per cubic centimeter or even higher. At that time the composite may be heat-treated again to impart desirable physical properties to the composite material.

Those skilled in the art are well acquainted with the basic techniques that may be used to implement this particular invention. Among the prior art disclosures that discuss such techniques, in addition to U.S. Pat. No. 5,480,678 mentioned above, are U.S. Pat. Nos. 5,587,203, 5,614,134, and 6,521,152 B1. The entire disclosure of each of U.S. Pat. No. 5,587,203, U.S. Pat. No. 5,614,134, and U.S. Pat. No. 6,521,152 B1 is incorporated by reference in the present application.

It has been found that the relative temperatures of intermediate heat treatment and final heat treatment provides a means for controlling and tailoring the mechanical properties (fracture toughness, wear resistance, oxidation resistance, etc.) of the composite being manufactured. The following Table provides some illustrations of this aspect of the present invention.

| Intermediate | Final | |
|---|---|---|
| Heat Treatment | Heat Treatment | |
| temperature | temperature | Expected Properties |
| none | none | Lowest density |
| none | 2500° C. | Intermediate density |
| 2500° C. | none | Intermediate density |
| 2500° C. | 2500° C. | Highest density |

As discussed above, ceramic composite preforms of this invention provide wheel beam keys that need no antioxidant coatings. The carbon-carbon composite beam keys of the invention can be coated with known penetration coatings and/or with barrier coatings. Also, a CVD process can be used to flash-coat the wheel beam keys with antioxidant material. If desired, wear-resistant coatings, such as tungsten carbide or silicon carbide coatings, can be applied to the wheel beam keys after they are manufactured.

### EXAMPLES

### Example 1

A carbon fiber preform block having dimensions of approximately 19 inches by 19 inches by 2 inches is made from a nonwoven fabric of oxidized PAN-based carbon fiber with a CVI-processed carbon matrix. Before infiltration, the block is carbonized under pressure and cut into bars having dimensions of approximately 1″×3″×15″. The bars are densified using 3 cycles of CVD processing. No final heat treatment is conducted. The bars are machined to their final shape as wheel beam keys. Liquid antioxidant formulations are applied to the carbon-carbon composite wheel beam keys prepared in this manner. A typical flexural strength for a carbon-carbon composite wheel beam key prepared in this manner is 69.3 KSI (kilograms/square inch). Typical bearing strengths in the x, y, and z directions for a wheel beam key prepared in this manner are 17.7 KSI, 13.3 KSI, and 55.8 KSI, respectively. Typical interlaminar shear strengths for a wheel beam key prepared in this manner are in the range 3.1 KSI-5.8 KSI. A typical bulk density of a wheel beam key prepared in this manner is 1.69 g/cc.

### Example 2

A carbon fiber preform laminate block having dimensions of approximately 15 inches by 15 inches by 0.75 inches is made from a woven fabric of carbonized PAN carbon fiber with a carbon matrix that is a hybrid of CVI and phenolic resin. The block is cut into bars having dimensions of approximately 0.75″×3″×15″. The bars are densified using 2 cycles of CVD processing and 1 cycle of pitch infiltration followed by charring to fill open pores. Then the bars are machined to their final shape as wheel beam keys. Liquid antioxidant formulations are applied to the carbon-carbon composite wheel beam keys prepared in this manner. A typical tensile strength for a carbon-carbon composite wheel beam key prepared in this manner is 94 KSI. A typical flexural strength for a carbon-carbon composite wheel beam key prepared in this manner is 78 KSI. Typical bearing strengths in the x, y, and z directions for a wheel beam key prepared in this manner are 27.0 KSI, 10.0 KSI, and 23.6 KSI, respectively. Typical interlaminar shear strengths for a wheel beam key prepared in this manner are in the range 1.3 KSI-2.2 KSI. A typical bulk density of a wheel beam key prepared in this manner is 1.59 g/cc.

### Example 3

A carbon fiber preform having dimensions of approximately 15 inches by 1 inch by 3 inches is made from woven bundles of PAN carbon fiber. The bars are densified using 3 cycles of CVD processing and 1 cycle of pitch infiltration followed by charring to fill open pores. Then the bars are machined to their final shape as wheel beam keys. Liquid antioxidant formulations are applied to the carbon-carbon composite wheel beam keys prepared in this manner.

### Example 4

An isotropic carbon fiber preform block having dimensions of approximately 15 inches by 15 inches by 2 inches is made from nonwoven fabric of oxidized PAN carbon fibers with a CVD/pitch carbon matrix. Prior to infiltration, the block is carbonized and then is cut into bars having dimensions of approximately 1″×3″×15″. The bars are densified using 3 cycles of CVD processing and 1 cycle of pitch infiltration to fill open pores. Then the bars are machined to their final shape as wheel beam keys. Liquid antioxidant formulations are applied to the carbon-carbon composite wheel beam keys prepared in this manner. A typical flexural strength for a carbon-carbon composite wheel beam key prepared in this manner is 64.3 KSI. Typical interlaminar shear strengths for a wheel beam key prepared in this manner are in the range 4.0 KSI-7.8 KSI. A typical bulk density of a wheel beam key prepared in this manner is 1.63 g/cc.

What is claimed is:

1. A carbon-carbon composite or carbon-ceramic composite wheel beam key, configured as a generally rectangular body having a neck area located at one end thereof and a through bore located at the opposite end thereof.

2. A carbon-carbon composite wheel beam key in accordance with claim 1, having a majority of its fibers aligned in the length direction of the key.

3. The carbon-carbon composite wheel beam key of claim 2, having a density of at least 1.5 g/cc.

4. The carbon-carbon composite wheel beam key of claim 3, having a density of at least 1.7 g/cc.

5. The carbon-carbon composite wheel beam key of claim 4, having a density of at least 1.9 g/cc.

6. The carbon-carbon composite wheel beam key of claim 5, having a density of at least 2.1 g/cc.

7. The carbon-carbon composite wheel beam key of claim 2, having a maximum internal porosity of 10% or less.

8. The carbon-carbon composite wheel beam key of claim 7, having a maximum internal porosity of 5% or less.

9. The carbon-carbon composite wheel beam key of claim 8, having a maximum internal porosity of 1% or less.

10. An aircraft wheel and beam key assembly, comprising:
a wheel having an outrigger boss about a rim edge thereof and a bracket mounted in a spoke face thereof; and
a beam key having a rectangular base and a neck at an end thereof, said neck being received by said bracket, wherein said beam key is made of a carbon-carbon composite or of a carbon-ceramic composite.

11. The aircraft wheel and beam key assembly of claim 10, wherein said beam key is a carbon-carbon composite made from a fibrous preform in which a major portion of the matrix fibers is aligned in the linear direction of the beam key and in which a minor portion of the fibers is aligned away from the linear direction of the beam key.

12. The aircraft wheel and beam key assembly of claim 11, wherein the carbon-carbon composite wheel beam key has a density of at least 1.5 g/cc and a maximum internal porosity of 10% or less.

13. A method of manufacturing a composite wheel beam key which comprises the steps of:
forming entirely from carbon fibers or from carbon fibers and ceramic materials a fibrous preform blank in a shape of a desired wheel beam key; and
densifying the fibrous preform to produce a carbon-carbon composite in the shape of said wheel beam key,
wherein, when said fibrous preform is formed entirely from carbon fibers, the resulting C—C composite wheel beam key is immersed in antioxidant to provide an antioxidant-coated carbon-carbon composite wheel beam key.

14. The method of manufacturing a carbon-carbon composite wheel beam key according to claim 13, which comprises the steps of:
forming a fibrous preform from carbon fiber precursors in the shape of the desired wheel beam key, with a majority of the fibers in the preform being oriented in the length direction of the key and with a minor portion of the fibers in the preform extending in the other two perpendicular directions of the key;
densifying the fibrous preform to produce a carbon-carbon composite in the shape of said wheel beam key;
immersing said C—C composite wheel beam key in antioxidant to provide an antioxidant-coated carbon-carbon composite wheel beam key; and
applying a hard, wear-resistant coating to the antioxidant-coated beam key.

15. The method of claim 14, wherein employing a composite wheel beam key as a component in the aircraft landing system brake assembly has the effect of reducing the weight of an aircraft landing system brake assembly.

16. The method of claim 14, wherein employing a composite wheel beam key as a component in the aircraft landing system brake assembly has the effect of enhancing the high temperature performance of an aircraft landing system brake assembly.
